(19) United States
(12) Patent Application Publication
(10) Pub. No.: US 2026/0237383 A1
(43) Pub. Date: Aug. 13, 2026

(54) INFORMATION PROCESSING METHOD

(71) Applicant: TOYOTA JIDOSHA KABUSHIKI KAISHA, Toyota-shi (JP)

(72) Inventor: Masayuki OKAMOTO, Nagoya-shi (JP)

(73) Assignee: TOYOTA JIDOSHA KABUSHIKI KAISHA, Toyota-shi (JP)

(21) Appl. No.: 19/462,112

(22) Filed: Jan. 28, 2026

(30) Foreign Application Priority Data
Feb. 4, 2025 (JP) 2025-017078

(51) Int. Cl. G10L 15/08; G06F 16/3329

(52) U.S. Cl. CPC G10L 15/083; G06F 16/33295

(57) ABSTRACT

An information processing method performed by an information processing apparatus includes acquiring an audio signal of speech from a plurality of speakers including a specific user, and extracting know-how information from text information acquired by recognizing the audio signal, based on speech of a question regarding a specific target item from the specific user.

### CROSS-REFERENCE TO RELATED APPLICATION

This application claims priority to Japanese Patent Application No. 2025-017078, filed on Feb. 4, 2025, the entire contents of which are incorporated herein by reference.

### TECHNICAL FIELD

The present disclosure relates to an information processing method.

### BACKGROUND

Technology related to learning systems for veterans’ knowledge, know-how, and the like has been known. Patent Literature (PTL) 1 discloses creating second-level script data based on first-level script data, and outputting a lecture including audio that vocalizes text data of the second-level script data and video of an avatar instructor.

### Citation List

### Patent Literature

PTL 1: JP 7473270 B1

### SUMMARY

However, the conventional machine learning-based configuration has not been considered for supporting the selection of content to be accumulated and inherited as veterans’ expertise (know-how).

It would be helpful to support the selection of content to be accumulated and inherited as know-how.

According to the present disclosure, an information processing method is an information processing method performed by an information processing apparatus, the information processing method including:

acquiring an audio signal of speech from a plurality of speakers including a specific user; and

extracting know-how information from text information acquired by recognizing the audio signal, based on speech of a question regarding a specific target item from the specific user.

According to an embodiment of the present disclosure, it is possible to support the selection of content to be accumulated and inherited as know-how.

### BRIEF DESCRIPTION OF THE DRAWINGS

In the accompanying drawings:

FIG. 1 is a block diagram illustrating an example of a configuration of an information processing apparatus according to an embodiment; and

FIG. 2 is a flowchart illustrating an example of operations of the information processing apparatus according to the embodiment.

### DETAILED DESCRIPTION

An embodiment of the present disclosure will be described below with reference to the drawings.

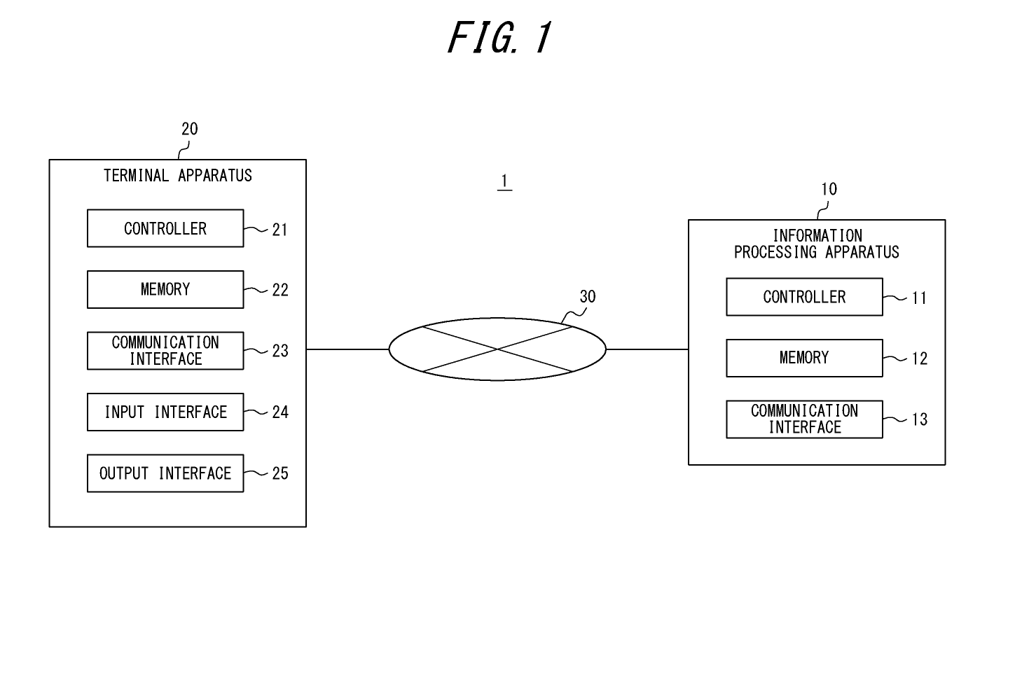

FIG. 1 is a diagram illustrating a configuration of an information processing system 1 according to the embodiment of the present disclosure. The configuration and outline of the information processing system 1 according to the embodiment of the present disclosure will be described with reference to FIG. 1.

The information processing system 1 includes an information processing apparatus 10 and a terminal apparatus 20. The information processing apparatus 10 and the terminal apparatus 20 are communicably connected via a network 30.

The information processing apparatus 10 is, for example, a server apparatus. The information processing apparatus 10 recognizes information to be accumulated as know-how from the audio signals of dialogues such as meetings with a plurality of speakers and registers it in a database.

The terminal apparatus 20 is any apparatus used by a user. The terminal apparatus 20 is, for example, a general purpose electronic device such as a smartphone, tablet, wearable device, or personal computer (PC), or a dedicated electronic device. In this embodiment, an example is described where a plurality of speakers use the same terminal apparatus 20 for dialogue, but different terminal apparatuses 20 may be used for each speaker, or a terminal apparatus 20 used by multiple speakers may be mixed with a terminal apparatus 20 used by one speaker. Even when a plurality of speakers use the same terminal apparatus 20, the user may distinguish speakers by using different microphones (input interfaces 24) for each speaker or by introducing themselves with their names for each utterance.

The network 30 is any communication network that allows communication between devices, and may include, for example, the internet and mobile communication networks.

An outline of the present embodiment will be first described, and details thereof will be described later. The information processing apparatus 10 extracts know-how from the dialogues of a plurality of speakers. Know-how refers to specific or specialized knowledge, skills, techniques, or information. For example, tasks such as screwing or assembly, operation of applications or software, or procedures for business execution may be applicable targets for know-how.

The information processing apparatus 10 acquires audio signals of speech from a plurality of speakers, including a specific user. The specific user may be a veteran with various knowledge and information, for example. The information processing apparatus 10 recognizes the audio signal and acquires text information. The information processing apparatus 10 may display the text information acquired by recognizing the audio signal of the user's speech on the display. The information processing apparatus 10 extracts know-how information from the text information based on the speech of a specific user's question regarding a specific target item. The information processing apparatus 10 may register the extracted know-how information in a database.

As shown in FIG. 1, the information processing apparatus 10 includes a controller 11, a memory 12, and a communication interface 13. The controller 11 includes at least one processor. The processor is a general purpose processor such as a CPU (Central Processing Unit) or a dedicated processor specialized for specific processing. The controller 11 executes processes related to operations of the information processing apparatus 10 while controlling components of the information processing apparatus 10. The memory 12 includes at least one semiconductor memory, magnetic memory, or optical memory. The memory 12 functions as, for example, a main memory or auxiliary storage device. The memory 12 stores data to be used in the operations of the information processing apparatus 10 and data obtained by the operations of the information processing apparatus 10. The communication interface 13 includes at least one external interface for communication. The interface for communication may be either a wired or wireless communication interface. In the case of wired communication, the interface for communication is, for example, a Local Area Network (LAN). In the case of wireless communication, the interface for communication is, for example, an interface compatible with mobile communication standards such as 5G, or an interface compatible with short-range wireless communication. The communication interface 13 receives data to be used in the operations of the information processing apparatus 10, and transmits data obtained by the operations of the information processing apparatus 10.

The functions of the information processing apparatus 10 are realized by executing a program according to the present embodiment by a processor corresponding to the controller 11. That is, the functions of the information processing apparatus 10 are realized by software. The program causes a computer to execute operations of the information processing apparatus 10, thereby causing the computer to function as the information processing apparatus 10. That is, the computer executes the operations of the information processing apparatus 10 in accordance with the program to thereby function as the information processing apparatus 10. In the present embodiment, the program can be recorded on a computer readable recording medium. The computer readable recording medium includes a non-transitory computer readable medium and is, for example, a magnetic recording apparatus, a semiconductor memory, or the like. The program is distributed, for example, by selling, transferring, or lending a portable recording medium such as a DVD on which the program is recorded. The program may also be distributed by storing the program in a storage of an external server and transmitting the program from the external server to another computer. The program may be provided as a program product. Some or all of the functions of the information processing apparatus 10 may be realized by a dedicated circuit corresponding to the controller 11. That is, some or all of the functions of the information processing apparatus 10 may be realized by hardware.

As illustrated in FIG. 1, the terminal apparatus 20 includes a controller 21, a memory 22, a communication interface 23, an input interface 14, and an output interface 25. The functions and configurations of the controller 21, memory 22, and communication interface 23 of the terminal apparatus 20 are similar to those of the controller 11, memory 12, and communication interface 13 of the information processing apparatus 10, so detailed explanation is omitted. The input interface 24 includes at least one interface for input. The interface for input may be, for example, a physical key, a touch screen, an audio sensor (microphone) that accepts audio input, or a camera that accepts gesture input, or the like. The input interface 24 accepts an operation for inputting data to be used for the operations of the terminal apparatus 20. The output interface 25 includes at least one interface for output. The interface for output is, for example, a display unit (display) for outputting information in the form of images, or a speaker for outputting information in the form of audio, or the like. The output interface 25 outputs data obtained by the operations of the terminal apparatus 20. Some or all of the functions of the terminal apparatus 20 may be realized by software, similar to the information processing apparatus 10, or may be realized by hardware.

### Operations of Information Processing System 1

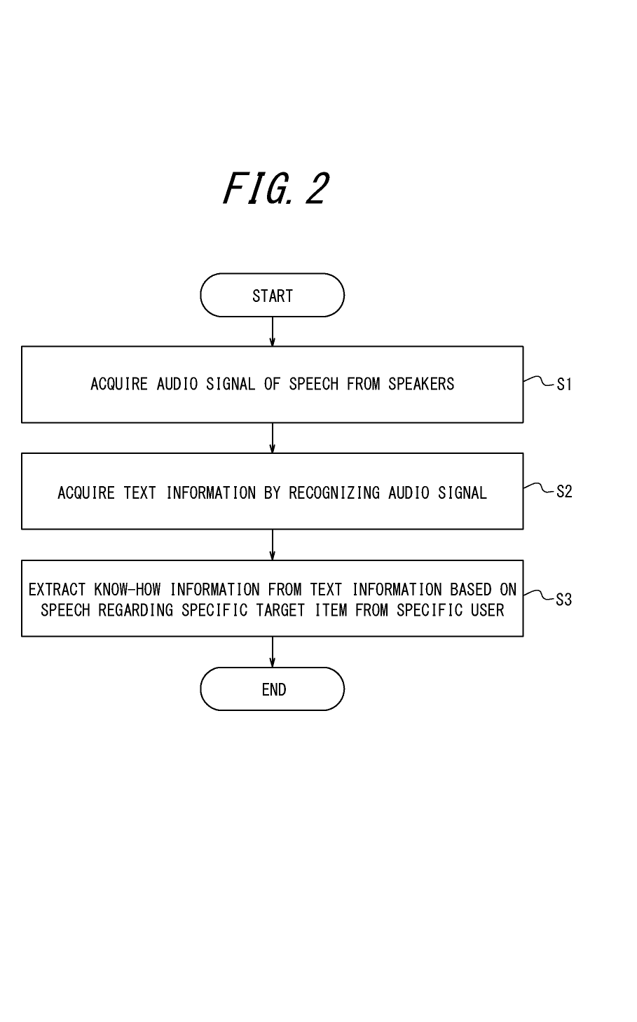

Operations of the information processing system 1 are described with reference to the flowchart in FIG. 2. The operations of the information processing system 1 described with reference to FIG. 2 may correspond to one of the information processing methods executed by the information processing apparatus 10. The operations of each step in FIG. 2 may be executed based on control by the controller 11 of the information processing apparatus 10.

S1: The controller 11 acquires an audio signal of speech from a plurality of speakers, including a specific user. Specifically, the controller 11 receives the audio signal of speech from a plurality of speakers from the terminal apparatus 20.

S2: The controller 11 recognizes the audio signal and acquires text information. The controller 11 may recognize the audio signal using existing speech recognition technology. The controller 11 may distinguish the speakers and acquire text information indicating the speech content along with information distinguishing each speaker. When multiple speakers are using the same terminal apparatus 20, the controller 11 may distinguish the speakers based on features of the audio signal, such as phonemes and MFCC (Mel-Frequency Cepstral Coefficient). When multiple speakers are using different terminal apparatuses 20, the controller 11 may distinguish the speakers based on the terminal apparatus 20 that transmitted the audio signal. The controller 11 may acquire audio signals for each speaker and be able to identify the speakers. The controller 11 may display the text information acquired by recognizing the audio signal of the user's speech on a display (output interface 25) in a way that distinguishes the speakers.

S3: The controller 11 extracts know-how information from the text information acquired by recognizing the audio signal based on the speech of a specific user's question regarding a specific target item.

The controller 11 may extract questions regarding the target item and answers related to them as know-how information from the text information based on the content of the speech. The controller 11 may determine the relevance to the target item based on keywords in the speech. For example, the controller 11 may acquire question-and-answer information regarding the target item (for example, that heat measures are a point of consideration regarding changes in materials) as know-how information. The controller 11 may acquire statements of questions regarding the design content as know-how during design review meetings. For example, if the controller 11 receives a question like "Will it trap heat?" regarding a design change from metal to resin,it may acquire that question-and-answer information as know-how.

The controller 11 may prioritize acquiring know-how information for question-and-answer sessions in which a specific user participated as a questioner or responder. If different terminal apparatuses 20 are used for each speaker, the controller 11 may determine the specific user based on information for identifying the terminal apparatus 20. The controller 11 may determine specific users whose speech content should be accumulated as know-how based on weighting according to attributes such as years of service and position of the speakers. Alternatively, the controller 11 may determine specific users whose speech content should be accumulated as know-how based on the context of the conversation.

The controller 11 may acquire audio signals of conversation content during meetings that refer to materials (for example, design review materials, etc.). The controller 11 may determine the correspondence between the speech content and the target item based on the content of the materials displayed on the screen during the meeting, the mouse pointer displayed in the materials, and the matching of the content of the materials with the speech, and may acquire conversations to be extracted as know-how.

The controller 11 may store the extracted know-how information in a database. The controller 11 may compare the extracted know-how information with know-how information previously stored in a database, and when there is no identical know-how information, the extracted know-how information may be stored as new know-how information in the database. That is, the controller 11 may register only new know-how information in the database.

As described above, in the information processing apparatus 10 according to the present embodiment, the controller 11 acquires the audio of a meeting involving multiple users, including veterans, and extracts know-how from the conversation content based on the speech of questions from veterans regarding the target item. That is, the controller 11 acquires the audio signal of speech from a plurality of speakers, including a specific user, and extracts know-how information from the text information acquired by recognizing the audio signal based on the speech of questions from the specific user regarding a specific target item. In this way, the controller 11 extracts know-how information from the text information acquired by recognizing the audio of the meeting based on the speech of questions from a specific user regarding a specific target item. Therefore, according to the information processing apparatus 10, it is possible to support the selection of content to be accumulated and inherited as know-how.

The present disclosure is not limited to the embodiment described above. For example, a plurality of blocks described in the block diagram may be integrated, or a block may be divided. Instead of executing a plurality of steps described in the flowchart in chronological order in accordance with the description, the plurality of steps may be executed in parallel or in a different order according to the processing capability of the apparatus that executes each step, or as required. Other modifications can be made without departing from the spirit of the present disclosure.

For example, some of the processing operations executed in the information processing apparatus 10 in the above embodiment may be executed in the terminal apparatus 20. Also, some of the processing operations executed in the terminal apparatus 20 in the above embodiment may be executed in the information processing apparatus 10.

1. An information processing method performed by an information processing apparatus, the information processing method comprising:
acquiring an audio signal of speech from a plurality of speakers including a specific user; and
extracting know-how information from text information acquired by recognizing the audio signal, based on speech of a question regarding a specific target item from the specific user.

2. The information processing method according to claim 1, wherein conversation content in a meeting with reference to a material is acquired as the audio signal.

3. The information processing method according to claim 1, wherein based on content of the speech, the question regarding the target item and an answer to the question are extracted from the text information as the know-how information.

4. The information processing method according to claim 1, wherein
the extracted know-how information is compared with know-how information previously stored in a database, and
when there is no identical know-how information, the extracted know-how information is stored as new know-how information in the database.

5. The information processing method according to claim 1, wherein the audio signal is acquired for each speaker.
